(19) United States
(12) Patent Application Publication
(10) Pub. No.: US 2010/0165003 A1
(43) Pub. Date: Jul. 1, 2010

(54) Image Display Apparatus And Projection Display Apparatus

(75) Inventors: Yoshinao HIRANUMA, Osaka (JP); Masutaka INOUE, Osaka (JP); Susumu TANASE, Osaka (JP); Tomoya TERAUCHI, Osaka (JP); Takaaki ABE, Osaka (JP); Masahiro HARAGUCHI, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/644,261

(22) Filed: Dec. 22, 2009

(30) Foreign Application Priority Data
Dec. 26, 2008 (JP) 2008-334999
Jan. 20, 2009 (JP) 2009-10311

(51) Int. Cl. G09G 5/10; G06F 3/038; H04N 9/475

(52) U.S. Cl. 345/690; 345/213; 348/514; 348/E09.034

(57) ABSTRACT

An image display apparatus includes a light source controller; an element controller; and an image analyzing unit. The light source controller controls the amount of the light to be emitted from the light source, based on the target light amount and a time constant. The image analyzing unit calculates saturation based on the signal values of the video input signals of the plurality of colors, and sets the time constant according to the saturation.

### CROSS REFERENCE TO RELATED APPLICATIONS

This application is based upon and claims the benefit of priority from prior Japanese Patent Application No. 2008-334999, filed on Dec. 26, 2008; and prior Japanese Patent Application No. 2009-10311, filed on Jan. 20, 2009; the entire contents of which are incorporated herein by reference.

### BACKGROUND OF THE INVENTION

1. Field of the Invention

The present invention relates to an image display apparatus and a projection display apparatus which include a light valve configured to modulate light emitted from a solid light source, based on a video input signal for each of multiple pixels forming a frame.

2. Description of the Related Art

There has been known a technique to reduce an amount of light emitted from a light source in order to prevent an image from flickering even when the luminance of the image changes greatly (for example, Japanese Patent Application Publication No. 2004-264668).

To be specific, firstly, the luminance of the image is calculated based on video input signals. Secondly, a luminance-adaptation adjustment value is calculated by time constant control based on the calculated luminance. Thirdly, when the luminance-adaptation adjustment value falls below a predetermined threshold value, the amount of light emitted from the light source is reduced to a predetermined light amount.

Thus, “flickering” caused by certain change in the amount of light emitted from the light source is suppressed by using the luminance-adaptation adjustment value calculated by time constant control as described above.

However, if the amount of light to be emitted from every light source is changed by using the time constant control processing, the total amount of light emitted from the light sources may possibly run short. Such shortage of the light amount causes “color shift.”

### SUMMARY OF THE INVENTION

A first aspect of an image display apparatus includes a light source (light source unit 10, white light source 310), and a light valve (liquid crystal panel 60, liquid crystal panel 350) configured to modulate light emitted from the light source, based on video input signals of a plurality of colors provided respectively for a plurality of pixels forming a frame. The image display apparatus includes: a light source controller (light source controller 230, light source controller 530) configured to control amount of light to be emitted from the light source; an element controller (element controller 240, element controller 540) configured to separately control signal values of the video input signals of the plurality of colors; and an image analyzing unit (image analyzing unit 220, image analyzing unit 520) configured to calculate a target light amount based on the signal values of the video input signals of the plurality of colors. The light source controller controls the amount of the light to be emitted from the light source, based on the target light amount and a time constant. The time constant is a value that determines an upper limit value for an amount of interframe change in the amount of the light to be emitted from light source. The image analyzing unit calculates saturation based on the signal values of the video input signals of the plurality of colors, and sets the time constant according to the saturation.

In the first aspect, the light source includes a plurality of solid light sources. The image analyzing unit sets a larger value for the time constant as the saturation becomes lower.

In the first aspect, the image analyzing unit calculates brightness based on the signal values of the video input signals of the plurality of colors, and sets a larger value for the time constant as weighted saturation obtained by weighting the saturation by the brightness becomes lower.

In the first aspect, the image analyzing unit calculates an interframe difference as a difference in the signal value of each of the video input signals of the plurality of colors between the frames, and calculates the time constant based on the interframe difference.

In the first aspect, the image analyzing unit calculates a target gain for each of the video input signals of the plurality of colors based on distribution of the signal values of the video input signals of the plurality of colors. The element controller separately controls the video input signals of the plurality of colors based on the respective target gains.

In the first aspect, the light source includes a plurality of solid light sources. The image analyzing unit sets a predetermined fixed value for the time constant when the saturation is higher than predetermined saturation, and sets a larger value than the fixed value for the time constant as the saturation becomes lower than the predetermined saturation.

In the first aspect, the light source is a white light source. The image analyzing unit sets a larger value for the time constant as the saturation becomes higher.

In the first aspect, the image analyzing unit calculates brightness based on the signal values of the video input signals of the plurality of colors, and sets a larger value for the time constant as a weighted saturation obtained by weighting the saturation by the brightness becomes higher.

In the first aspect, the image analyzing unit calculates an interframe difference as a difference in the signal value of each of the video input signals of the plurality of colors between the frames, and calculates the time constant based on the interframe difference.

In the first aspect, the image analyzing unit calculates a target gain based on distribution of the signal values of the video input signals of the plurality of colors. The element controller separately controls the video input signals of the plurality of colors based on the target gain.

In the first aspect, the light source is a white light source. The image analyzing unit sets a predetermined fixed value for the time constant as the saturation becomes lower than predetermined saturation, and sets a larger value than the fixed value for the time constant as the saturation becomes higher than the predetermined saturation.

A second aspect of a projection display apparatus includes a light source (light source unit 10, white light source 310), a light valve (liquid crystal panel 60, liquid crystal panel 350), and a projection unit (projection unit 110, projection unit 410). The light valve configured to modulate light emitted from the light source, based on video input signals of a plurality of colors provided respectively for a plurality of pixels forming a frame. The projection display apparatus includes: a light source controller configured to control amount of light to be emitted from the light source; an element controller configured to separately control signal values of the video input signals of the plurality of colors; and an image analyzing unit configured to calculate a target light amount based on the signal values of the video input signals of the plurality of colors. The light source controller controls the amount of the light to be emitted from the light source, based on the target light amount and a time constant. The time constant is a value that determines an upper limit value for an amount of interframe change in the amount of the light to be emitted from light source. The image analyzing unit calculates saturation based on the signal values of the video input signals of the plurality of colors, and sets the time constant according to the saturation.

### BRIEF DESCRIPTION OF TEE DRAWINGS

FIG. 1 is a diagram showing a projection display apparatus 100 according to a first embodiment;

FIG. 2 is a block diagram showing a control unit 200 according to the first embodiment;

FIG. 3 is a diagram showing a time constant τ according to the first embodiment;

FIG. 4 is a diagram showing light source control processing according to the first embodiment;

FIG. 5 is a diagram showing signal control processing according to the first embodiment;

FIG. 6 is a flow chart showing operation of the projection display apparatus 100 according to the first embodiment;

FIG. 7 is a diagram showing a comparison result of comparative examples and an example;

FIG. 8 is a diagram showing a time constant τ according to Modification 1;

FIG. 9 is a diagram for describing control of a target gain G_{T} according to Modification 2;

FIG. 10 is diagram for describing control of the target gain G_{T} according to Modification 2;

FIG. 11, is a diagram showing a projection display apparatus 400 according to a second embodiment;

FIG. 12 is a block diagram showing a control unit 500 according to the second embodiment;

FIG. 13 is a diagram showing a time constant τ according to the second embodiment;

FIG. 14 is a diagram showing light source control processing according to the second embodiment;

FIG. 15 is a diagram showing signal control processing according to the second embodiment;

FIG. 16 is a flow chart showing operation of the projection display apparatus 400 according to the second embodiment;

FIG. 17 is a diagram showing a comparison result of comparative examples and an example;

FIG. 18 is a diagram showing a time constant τ according to Modification 1;

FIG. 19 is a diagram for describing control of a target gain G_{T} according to Modification 2;

FIG. 20 is a diagram for describing control of the target gain G_{T} according to Modification 2; and

FIG. 21 is a diagram showing an image display apparatus 600 according to Modification 4.

### DETAILED DESCRIPTION OF THE EMBODIMENTS

Hereinafter, an image display apparatus according to embodiments of the present invention will be described with reference to the drawings. In the description of the drawings below, identical or similar reference numerals are given to identical or similar portions.

However, it should be noted that the drawings are schematic and dimensional ratios and the like are different from actual ones. Accordingly, specific sizes and the like should be determined in consideration of the description below. Moreover, needless to say, there are some differences in dimensional relationships and ratios between the mutual drawings.

### Outline of Embodiments

Firstly, the image display apparatus according to an embodiment includes solid light sources of multiple colors, and light valves configured to modulate light emitted from the solid light sources of the multiple colors, based on video input signals of the plurality of colors provided respectively for multiple pixels forming a frame. The image display apparatus includes: a light source controller configured to separately control amount of light to be emitted from the solid light sources of the multiple colors; an element controller configured to separately control signal values of the video input signals of the multiple colors; and an image analyzing unit configured to calculate a target light amount for each of the solid light sources of the multiple colors based on the signal values of the video input signals of the multiple colors.

The light source controller separately controls the amount of the light to be emitted from the solid light sources of the multiple colors, based on the target light amount calculated for the solid light sources of the multiple colors and a time constant. The time constant is a value that determines an upper limit value for an amount of interframe change in the amount of the light to be emitted from each of the solid light sources of the multiple colors.

As a first example, the image analyzing unit calculates saturation based on the signal values of the video input signals of the multiple colors, and sets a larger value for the time constant as the saturation becomes lower.

As described above, in control of the amount of light to be emitted from each of the solid light sources of the multiple colors, the time constant that determines the upper limit value for the amount of change in the light amount is used. Accordingly, “flickering” is suppressed. Moreover, a larger value is set for the time constant as the saturation becomes lower. Accordingly, deviation of the amount of light to be emitted from each of the solid light sources is suppressed, so that “color shift” is suppressed.

As a second example, the image analyzing unit calculates saturation based on the signal values of the video input signals of the multiple colors, sets a predetermined fixed value for the time constant when the saturation is higher than a predetermined threshold, and sets a larger value than the fixed value for the time constant as the saturation becomes lower than the predetermined threshold.

As described above, in control of the amount of light to be emitted from each of the solid light sources of the multiple colors, the time constant that determines the upper limit value for the amount of change in the light amount is used. Accordingly, “flickering” is suppressed. Moreover, when the saturation is lower than the predetermined threshold, a value larger than the fixed value is set for the time constant. Accordingly, deviation of the amount of light to be emitted from each of the solid light sources is suppressed, so that “color shift” is suppressed.

Secondly, the image display apparatus according to another embodiment includes a white light source, and a light valve configured to modulate light emitted from the white light source, based on video input signals of multiple colors provided respectively for multiple pixels forming a frame. The image display apparatus including: a light source controller configured to control an amount of light to be emitted from the white light source; an element controller configured to separately control signal values of the video input signals of the multiple colors; and an image analyzing unit configured to calculate a target light amount based on the signal values of the video input signals of the multiple colors.

The light source controller controls the amount of the light to be emitted from the white light source, based on the target light amount and a time constant. The time constant is a value that determines an upper limit value for an amount of interframe change in the amount of the light to be emitted from the white light source.

As a first example, the image analyzing unit calculates saturation based on the signal values of the video input signals of the multiple colors, and sets a larger value for the time constant as the saturation becomes higher.

As described above, in control of the amount of light to be emitted from the white light source, the time constant that determines the upper limit value for the amount of change in the light amount is used. Accordingly, “flickering” is suppressed. Moreover, a larger value is set as the time constant as the saturation becomes higher. Accordingly, “color shift” is suppressed in an image with high saturation having a noticeable difference in the light amount drop contribution among the video input signals Rᵢₙ, Gᵢₙ, and Bᵢₙ.

As a second example, the image analyzing unit calculates saturation based on the signal values of the video input signals of the multiple colors, sets a predetermined fixed value for the time constant as the saturation becomes lower than a predetermined threshold, and sets a larger value than the fixed value for the time constant as the saturation becomes higher than the predetermined threshold.

As described above, in control of the amount of light to be emitted from the white light source, the time constant that determines the upper limit value for the amount of change in the light amount is used. Accordingly, “flickering” is suppressed. Moreover, as the saturation becomes higher than the predetermined threshold, a value larger than the fixed value is set for the time constant. Accordingly, “color shift” is suppressed in an image with high saturation having a noticeable difference in the light amount drop contribution among the video input signals Rᵢₙ, Gᵢₙ, and Bᵢₙ.

Incidentally, the light amount drop contribution is a degree of the amount of increase in the signal value within a range not exceeding the upper limit signal value, when the amount of light to be emitted from the white light source is reduced and the signal value is increased by the signal control processing, in the backlight control processing.

Here, when a solid light source is used as the light source, a larger value is set for the time constant as the saturation becomes lower. This is because “color shift” attributed to shortage of the light amount in a low saturation region is remarkable when the solid light source is used.

On the other hand, when the white light source is used as the light source, a larger value is set for the time constant as the saturation becomes higher. This is because “color shift” attributed to shortage of the light amount in a higher saturation region is remarkable when the white light source is used.

Hereinafter, a projection display apparatus will be illustrated as the image display apparatus. However, needless to say, the image display apparatus will not be limited to the projection display apparatus. Specifically, the image display apparatus may be another display unit such as a liquid crystal television.

### First Embodiment

### (Configuration of Projection Display Apparatus)

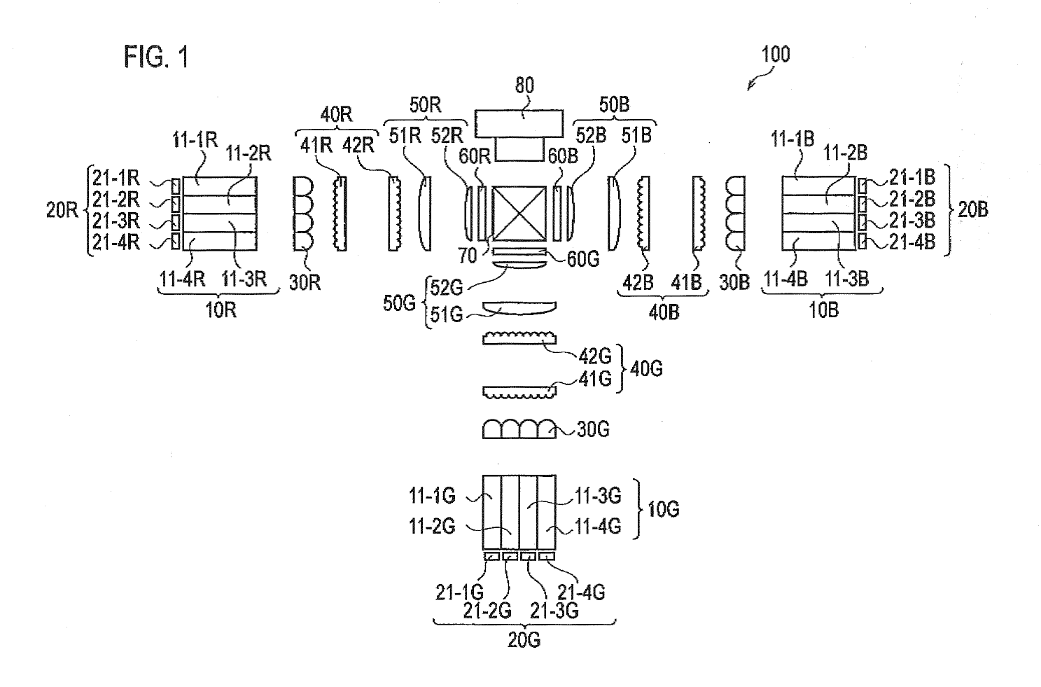

Hereinafter, a projection display apparatus according to a first embodiment will be described with reference to the drawing. FIG. 1 is a diagram showing a projection display apparatus 100 according to the first embodiment.

As shown in FIG. 1, the projection display apparatus 100 includes light source units 10, temperature adjustment units 20, cylindrical lenses 30, fly-eye lens units 40, condensing lens groups 50, liquid crystal panels 60, a cross dichroic mirror 70, and a projection unit 80.

The light source unit 10 is provided for each color of red, green, and blue. In other words, the light source units 10 include a light source unit 10R, a light source unit 10G, and a light source unit 10B. Each light source unit 10 has multiple solid light sources 11. The solid light source 11 is a laser diode (LD) or a light emitting diode (LED).

The light source unit 10R is formed of solid light sources 11-1R to 11-4R. The light source unit 10G is formed of solid light sources 11-1G to 11-4G. The light source unit 10B is formed of solid light sources 11-1B to 11-4B.

The number of the solid light sources 11 provided in each light source unit 10 is not limited. A single solid, light source 11 may be provided in each of the light source units 10.

The temperature adjustment unit 20 is provided for each color of red, green, and blue. In other words, temperature adjustment units 20 include a temperature adjustment unit 20R, a temperature adjustment unit 20G, and a temperature adjustment unit 20B. Each temperature adjustment unit 20 has multiple temperature adjusters 21. The temperature adjuster 21 is a cooling unit such as a Peltier device or a blower fan, for example. The temperature adjuster 21 may be a heating unit such as a heater.

The temperature adjustment unit 20R is formed of temperature adjusters 21-1R to 21-4R. The temperature adjusters 21-1R to 21-4R are provided respectively to the solid light sources 11-1R to 11-4R. The temperature adjusters 21-1R to 21-4R are configured to respectively adjust the temperatures of the solid light sources 11-1R to 11-4R.

The temperature adjustment unit 20G is formed of temperature adjusters 21-1G to 21-4G. The temperature adjusters 21-1G to 21-4G are provided respectively to the solid light sources 11-1G to 11-4G. The temperature adjusters 21-1G to 21-4G are configured to respectively adjust the temperatures of the solid light sources 11-1G to 11-4G.

The temperature adjustment unit 20B is formed of temperature adjusters 21-1B to 21-4B. The temperature adjusters 21-1B to 21-4B are provided respectively to the solid light sources 11-1B to 11-4B. The temperature adjusters 21-1B to 21-4B are configured to respectively adjust the temperatures of the solid light sources 11-1B to 11-4B.

The cylindrical lenses 30 are provided for each color of red, green, and blue. In other words, the cylindrical lenses 30 include cylindrical lenses 30R, cylindrical lenses 30G, and cylindrical lenses 30B.

The cylindrical lenses 30R are configured to align the polarization states of red component light emitted from the light source unit 10R, respectively. The cylindrical lenses 30R are also configured to form linear red component light.

The cylindrical lenses 30G are configured to align the polarization states of green component light emitted from the light source unit 10G, respectively. The cylindrical lenses 30G are configured to form linear green component light.

The cylindrical lenses 30B are configured to align the polarization states of blue component light emitted from the light source unit 10B, respectively. The cylindrical lenses 30G are configured to form linear blue component light.

The fly-eye lens unit 40 is provided for each color of red, green, and blue. In other words, the fly-eye lens units 40 include a fly-eye lens unit 40R, a fly-eye lens unit 40G, and a fly-eye lens unit 40B.

The fly eye lens unit 40R is formed of a fly-eye lens 41R and a fly-eye lens 42R. Each of the fly-eye lens 41R and the fly-eye lens 42R is formed of multiple microlenses. Each of the microlenses is configured to converge the red component light emitted from the light source unit 10R so that the whole surface of a liquid crystal panel 60R may be irradiated with the red component light emitted from the light source unit 10R.

The fly eye lens unit 40G is formed of a fly-eye lens 41G and a fly-eye lens 42G. Each of the fly-eye lens 41G and the fly-eye lens 42G is formed of multiple microlenses. Each of the microlenses is configured to converge the green component light emitted from the light source unit 10G so that the whole surface of a liquid crystal panel 60G may be irradiated with the green component light emitted from the light source unit 10G.

The fly eye lens unit 40B is formed of a fly-eye lens 41B and a fly-eye lens 42B. Each of the fly-eye lens 41B and the fly-eye lens 42B are formed of multiple microlenses. Each of the microlenses is configured to converge the blue component light emitted from the light source unit 10B so that the whole surface of a liquid crystal panel 60B may be irradiated with the blue component light emitted from the light source unit 10B.

The condensing lens group 50 is provided for each color of red, green, and blue. In other words, the condensing lens groups 50 include a condensing lens group 50R, a condensing lens group 50G, and a condensing lens group 50B.

The condensing lens group 50R is formed of a condensing lens 51R and a condensing lens 52R. The condensing lens 51R and the condensing lens 52R are configured to converge the red component light emitted from the light source unit 10R.

The condensing lens group 50G is formed of a condensing lens 51G and a condensing lens 52G. The condensing lens 51G and the condensing lens 52G are configured to converge the green component light emitted from the light source unit 10G.

The condensing lens group 50B is formed of a condensing lens 51B and a condensing lens 52B. The condensing lens 51B and the condensing lens 52B are configured to converge the blue component light emitted from the light source unit 10B.

The liquid crystal panel 60 is provided for each color of red, green, and blue. In other words, the liquid crystal panels 60 include the liquid crystal panel 60R, the liquid crystal panel 60G, and the liquid crystal panel 60B.

The liquid crystal panel 60R is a light valve configured to modulate the red component light emitted from the light source unit 10R, based on red output signals Rₒᵤₜ.

The liquid crystal panel 60G is a light valve configured to modulate the green component light emitted from the light source unit 10G, based on green output signals Gₒᵤₜ.

The liquid crystal panel 60B is a light valve configured to modulate the blue component light emitted from the light source unit 10B, based on blue output signals Bₒᵤₜ.

The red output signals Rₒᵤₜ, the green output signals Gₒᵤₜ, and the blue output signals Bₒᵤₜ form video output signals. The video output signals are signals for multiple pixels forming one frame. Accordingly, each of the liquid crystal panel 60R, the liquid crystal panel 60G, and the liquid crystal panel 60B is configured to modulate the corresponding color component light for each of the multiple pixels.

The cross dichroic mirror 70 is configured to combine together the color component light emitted from the liquid crystal panels 60. The cross dichroic mirror 70 is configured to emit the combine light to the projection unit 80 side.

The projection unit 80 is configured to project the combine light emitted from the cross dichroic mirror 70, on a screen (not shown) or the like.

### (Configuration of Control Unit)

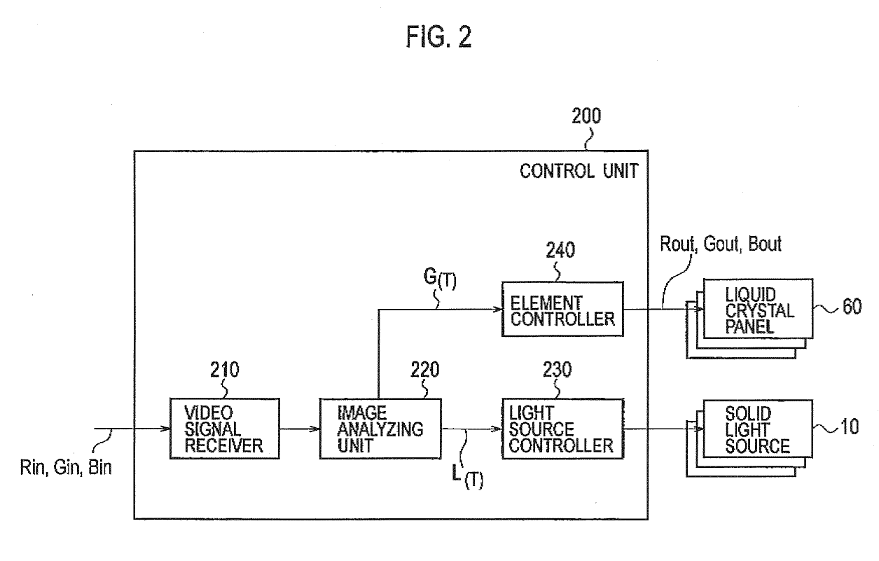

Hereinafter, a control unit according to the first embodiment will be described with reference to the drawing. FIG. 2 is a block diagram showing a control unit 200 according to the first embodiment. The control unit 200 is provided in the projection display apparatus 100, and configured to control the projection display apparatus 100.

As shown in FIG. 2, the control unit 200 includes a video signal receiver 210, an image analyzing unit 220, a light source controller 230, and an element controller 240.

The video signal receiver 210 is configured to receive video input signals from an external device (not shown) such as a DVD player or a TV tuner. The video input signals include red input signals Rᵢₙ, green input signals Gᵢₙ, and blue input signals Bᵢₙ. The video input signals are signals inputted respectively to multiple pixels forming one frame.

The image analyzing unit 220 is configured to perform preprocessing for backlight control processing. The backlight control processing is processing to control the amount of light to be emitted from the light source unit 10, based on the signal values of the video input signals (for example, indexes that show brightness). Moreover, the backlight control processing is processing to convert the video input signals respectively into video output signals in accordance with a control amount of the amount of light to be emitted from the light source unit 10. Here, it should be noted that the backlight control processing is performed for each, color of red, green, and blue.

Since the backlight control processing is performed for each color in the first embodiment, the red input signals Rᵢₙ, the green input signals Gᵢₙ, and the blue input signals Bᵢₙ are used as the indexes that show brightness.

Specifically, the image analyzing unit 220 calculates a target light amount L_{T} and a target gain G_{T} based on the video input signals. The target light amount L_{T} is used for controlling the amount of light to be emitted from the light source unit 10. The target gain G_{T} is used for controlling the conversion of the video input signals into the video output signals.

In the first embodiment, the target light amount L_{T} may be considered as a ratio of a representative value of the video input signals for the multiple pixels forming a frame, and an upper limit signal value. Similarly to the target light amount L_{T}, the target gain G_{T} may be also considered as a ratio of a representative value of the video input signals for the multiple pixels forming the frame, and the upper limit signal value. As the representative values of the video input signals, the maximum value for the video input signals for the multiple pixels forming the frame, and a mean value of the video input signals for the multiple pixels forming the frame, are used.

The backlight control processing is performed for each color of red, green, and blue, as mentioned above. Therefore, it should be noted that the target light amount L_{T} and the target gain G_{T} are calculated for each color of red, green, and blue.

Here, the image analyzing unit 220 calculates a time constant τ based on the signal values of the video input signals. The time constant τ is a value that determines the upper limit value for the amount of interframe change in the amount of light to be emitted from each of the multiple light source units 10. Specifically, the image analyzing unit 220 calculates saturation (for example, a mean value of saturation) based on, the signal values of the video input signals, and sets a larger value for the time constant τ as the saturation becomes lower.

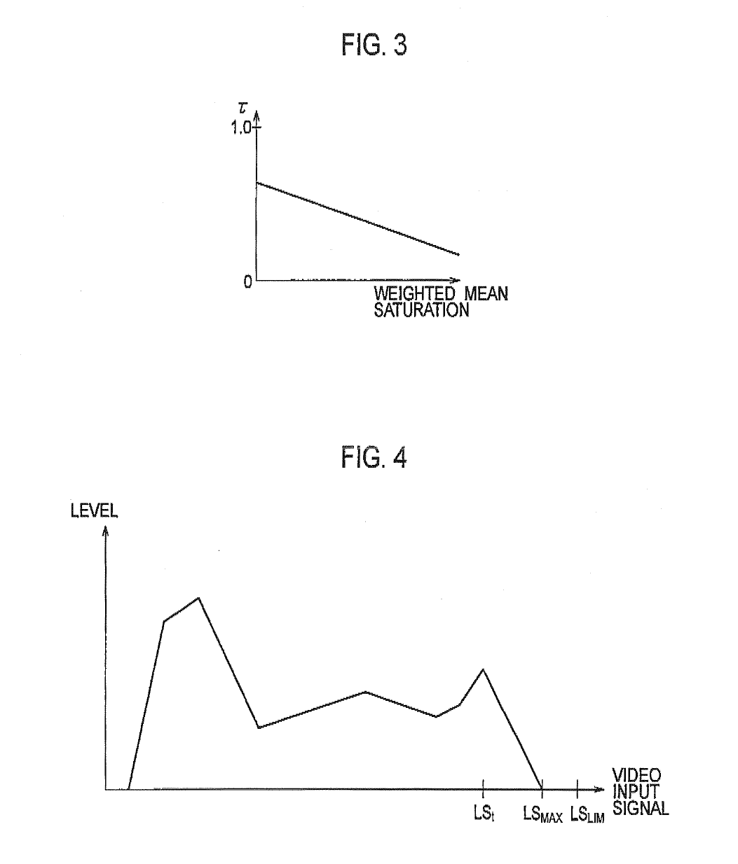

In the first embodiment, the image analyzing unit 220 calculates brightness based on the signal values of the video input signals. Then, the image analyzing unit 220 sets a larger value for the time constant τ as a mean value of weighted saturation (hereinafter, weighted mean saturation) obtained by weighting the saturation by the brightness becomes lower. For example, as shown in FIG. 3, a larger value is set for the time constant τ as the weighted mean saturation becomes lower. The value of the time constant τ is within a range of the minimum (≧0) to the maximum value (≦1).

The weighted mean saturation WSₐᵥₑ is calculated in accordance with the following equation, for example. As shown in the following equation, use of the weighted mean saturation WSₐᵥₑ reduces computational complexity compared to a case of using the saturation.

$${WS}_{ave} = \frac{{\sum }_{i}^{k} {V}_{i} {S}_{i}}{k} = \frac{{\sum }_{i}^{k} ( {max}_{i} - {min}_{i} )}{k} \\ {V}_{i} = {max}_{i} \\ {S}_{i} = \frac{{max}_{i} - {min}_{i}}{{max}_{i}} \qquad [ Equation 1 ]$$

wherein maxᵢ=max(Rᵢ, Gᵢ, Bᵢ), minᵢ=min(Rᵢ, Gᵢ, Bᵢ), i=pixel position.

The image analyzing unit 220 outputs the target light amount L_{T} and the time constant τ to the light source controller 230. The image analyzing unit 220 also outputs the target gains G_{T} to the element controller 240.

The light source controller 230 is configured to control the amount of light to be emitted from the light source unit 10 for each color of red, green, and blue, based on the corresponding target light amount L_{T} and the time constant τ. Specially, the light source controller 230 controls each light source unit 10 so that the amount of light to be emitted from the light source unit 10 may be the light amount calculated using the target light amount L_{T} and the time constant τ.

The light source controller 230 calculates an amount of decrease in the amount of light to be emitted from the light source unit 10R, based on a target light amount L_{T}R calculated for red and the time constant τ. The amount of decrease here is an amount of decrease from the upper limit amount of the red component light to be emitted from the light source unit 10R.

The light source controller 230 may uniformly reduce the amount of light to be emitted from the solid light sources 11-1R to 11-4R so that the amount of light to be emitted from the solid light sources 11-1R to 11-4R may be the light amount calculated using the target light amount L_{T}R and the time constant τ. Alternatively, the light source controller 230 may preferentially reduce the amount of light to be emitted from a solid light source having poor luminous efficiency among the solid light sources 11-1R to 11-4R so that the amount of light to be emitted from the solid light sources 11-1R, to 11-4R may be the light amount calculated using the target light amount L_{T}R and the time constant τ.

Similarly, the light source controller 230 calculates an amount of decrease in the amount of light to be emitted from the light source unit 10G, based on a target light amount L_{T}G calculated for green and the time constant τ. The amount of decrease here is an amount of decrease from the upper limit amount of the green component light to be emitted from the light source unit 10G.

The light source controller 230 may uniformly reduce the amount of light to be emitted from the solid light sources 11-1G to 11-4G so that the amount of light to be emitted from the solid light sources 11-1G to 11-4G may be the light amount calculated using the target light amount L_{T}G and the time constant τ. Alternatively, the light source controller 230 may preferentially reduce the amount of light to be emitted from a solid light source having poor luminous efficiency among the solid light sources 11-1G to 11-4G so that the amount of light to be emitted from the solid light sources 11-1G to 11-4G may be the light amount calculated using the target light amount L_{T}G and the time constant τ.

Further, the light source controller 230 calculates an amount of decrease in the amount of light to be emitted from the light source unit 10B, based on a target light amount L_{T}B calculated for blue and the time constant τ. The amount of decrease here is an amount of decrease from the upper limit amount of the blue component light to be emitted from the light source unit 10B.

The light source controller 230 may uniformly reduce the amount of light to be emitted from the solid light sources 11-1B to 11-4B so that the amount of light to be emitted from the solid light sources 11-1B to 11-4B may be the light amount calculated using the target light amount L_{T}B and the time constant τ. Alternatively, the light source controller 230 may preferentially reduce the amount of light to be emitted from a solid light source having poor luminous efficiency among the solid light source 11-1B to 11-4B so that the amount of light to be emitted from the solid light sources 11-1B to 11-4B may be the light amount calculated using the target light amount L_{T}B and the time constant τ.

The element controller 240 is configured to control the signal values of the video input signals for the multiple pixels, for each color of red, green, and blue. Specifically, the element controller 240 converts the video input signals for the multiple pixels respectively into the video output signals for the multiple pixels. In other words, the element controller 240 converts the red input signals Rᵢₙ into the red output signals Rₒᵤₜ. Similarly, the element controller 240 converts the green input signals Gᵢₙ into the green output signals Gₒᵤₜ, and converts the blue input signals Bᵢₙ into the blue output signals Bₒᵤₜ.

Based on a target gain. G_{T}R calculated for red, the element controller 240 converts the red input signals Rᵢₙ into the red output signals Rₒᵤₜ so that the red output signals Rₒᵤₜ may become larger than the red input signals Rᵢₙ.

Similarly, based on the target gain G_{T}G calculated for green, the element controller 240 converts the green input signals Gᵢₙ into the green output signals Gₒᵤₜ so that the green output signals Gₒᵤₜ may become larger than the green input signals Gᵢₙ.

Based on the target gain G_{T}B calculated for blue, the element controller 240 converts the blue input signals Bᵢₙ into the blue output signals Bₒᵤₜ so that the blue output signals Bₒᵤₜ may become larger than the blue input signals Bᵢₙ.

### (Light Source Control Processing)

Hereinafter, light source control processing of the backlight control processing according to the first embodiment will be described with reference to the drawing. FIG. 4 is a diagram showing the light source control processing according to the first embodiment. Specifically, FIG. 4 is a diagram showing a histogram of the signal value of the video input signal for each of the multiple pixels.

In FIG. 4, a maximum signal value LS_{MAX} is the maximum value for the video input signal for each of the multiple pixels. An upper limit signal value LS_{LIM} is the upper limit value for the video input signal. A target signal value LS_{T} is a signal value corresponding to the target light amount L_{T} calculated based on the video input signals.

As shown in FIG. 4, when the maximum signal value LS_{MAX} is smaller than the upper limit signal value LS_{LIM}, the amount of light to be emitted from the solid light source can be reduced. As mentioned above, the light source controller 230 controls each solid light source so that the amount of light to be emitted from the solid light source may be the light amount calculated based on the target light amount L_{T} and the time constant τ.

The histogram shown in FIG. 4 is created for each color of red, green, and blue. Moreover, the light source control processing is performed for each color of red, green, and blue.

### (Signal Control Processing)

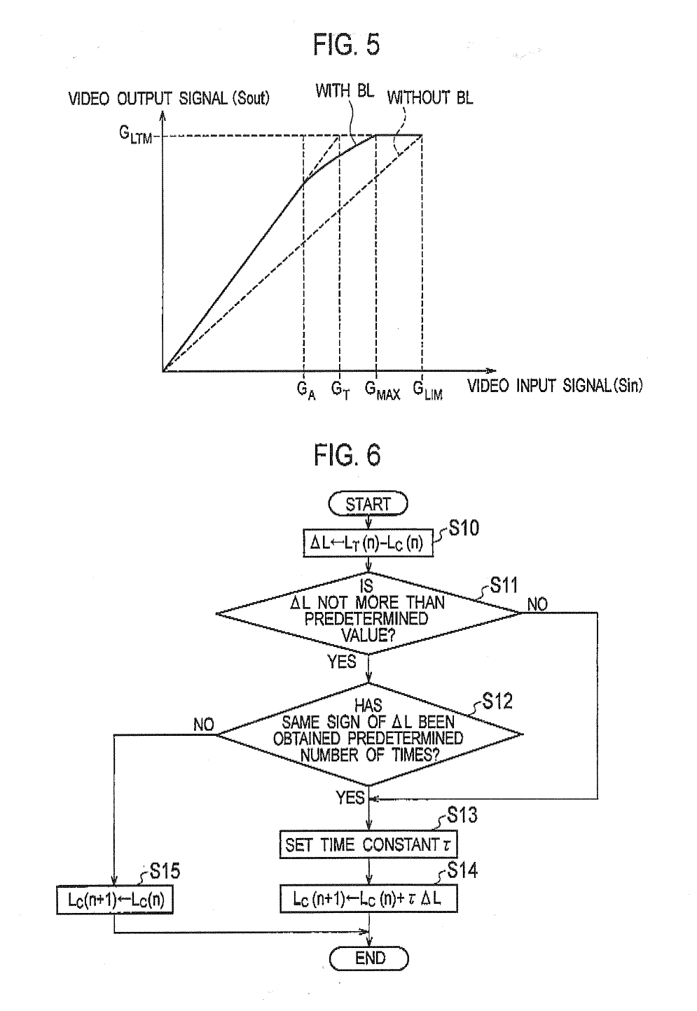

Hereinafter, signal control processing of the backlight control processing according to the first embodiment will be described with reference to the drawing. FIG. 5 is a diagram showing the signal control processing according to the first embodiment. Specifically, FIG. 5 is a diagram showing conversion characteristics for converting the video input signal into the video output signal.

In FIG. 5, a gain maximum value G_{MAX} is the maximum value for the video input signal for each of the multiple pixels. A gain upper limit value G_{LIM} is the upper limit value for the video input signal for each of the multiple pixels. The target gain G_{T} is a value calculated based on the target light amount L_{T} (or the target signal value LS_{T}). For example, target gain G_{T}/gain upper limit value G_{LIM} is identical to target signal value LS_{T}/upper limit signal value LS_{LIM}.

As a premise, a conversion rate of the video input signal (Sᵢₙ) to the video output signal (Sₒᵤₜ) is 1 to 1 when the backlight control processing is not performed, as shown in FIG. 5.

Under the assumption of such a relationship, the conversion rate of the video input signal (Sᵢₙ) to the video output signal (Sₒᵤₜ) when the backlight control processing is performed is represented by the following equation.

$${S}_{out} = {S}_{in} \times \frac{{G}_{LIM}}{{G}_{T}} ( O \leq {S}_{in} \leq {G}_{A} ) \\ {S}_{out} = {G}_{LIM} - \frac{{{G}_{LIM} ( {G}_{LIM} - {S}_{in} )}^{2}}{4 {G}_{T} ( {G}_{MAX} - {G}_{T} )} ( {G}_{A} < {S}_{in} \leq {G}_{MAX} ) \\ {S}_{out} = {G}_{LIM} ( {G}_{MAX} < {S}_{in} \leq {G}_{LIM} ) \qquad [ Equation 2 ]$$

wherein G_{A}=2 G_{T}−G_{MAX}, G_{LIM}=gain upper limit value, G_{MAX}=gain maximum value, G_{T}=target gain.

### (Operation of Projection Display Apparatus)

Hereinafter, operation of the projection display apparatus according to the first embodiment will be described with reference to the drawing. FIG. 6 is a flow chart showing operation of the projection display apparatus 100 according to the first embodiment. Specifically, FIG. 6 is a diagram showing a method for determining the light emission amount of the (n+1)-th frame.

In FIG. 6, L_{T}(n) is the target light amount L_{T} of the n-th frame. L_{C}(n) is the light emission amount of the n-th frame. L_{C}(n+1) is the light emission amount of the (n+1)-th frame.

As shown in FIG. 6, at Step 10, the control unit 200 sets a difference between the target light amount L_{T}(n) and the light emission amount L_{C}(n), as ΔL.

At Step 11, the control unit 200 determines whether ΔL is not more than a predetermined value. The control unit 200 goes to processing of Step 12 when ΔL is not more than the predetermined value. On the other hand, the control unit 200 goes to processing of Step 13 when ΔL is larger than the predetermined value.

At Step 12, the control unit 200 determines whether the same sign of ΔL has been obtained a predetermined number of times. In other words, the control unit 200 determines whether the target light amount L_{T} is continuously increased (or decreased) in a predetermined number of frames. The control unit 200 goes to the processing of Step 13 when the sign of ΔL has been the same the predetermined number of times. On the other hand, the control unit 200 goes to processing of Step 15 when the same sign of ΔL has not been obtained the predetermined number of times.

At Step 13, the control unit 200 sets the time constant τ based on the saturation (in the first embodiment, weighted mean saturation) calculated based on the video input signals. As the video input signals, video input signals for multiple pixels forming the n-th frame are used, for example.

At Step 14, the control unit 200 adds a value obtained by multiplying ΔL by the time constant τ, to the light emission amount L_{C}(n). The control unit 200 sets the result of the calculation as the light emission amount L_{C}(n+1).

At Step 15, the control unit 200 sets the light emission amount L_{C}(n) as the light emission amount L_{C}(n+1).

### (Advantageous Effect)

In the first embodiment, in control of the light emission amount, the time constant τ that determines the upper limit value for the amount of change in the light amount is used. Accordingly, “flickering” is suppressed. Moreover, a larger value is set for the time constant τ as the saturation calculated based on the video input signals becomes lower. Accordingly, deviation of the amount of light to be emitted from each light source unit 10 is suppressed, so that “color shift” is suppressed.

In the first embodiment, a larger value is set for the time constant τ as the weighted mean saturation becomes lower. An image having a lower weighted mean saturation has many bright pixels of achromatic color. Accordingly, a larger value is set as the time constant c in such an image so that “color shift” is suppressed.

### [Comparison Result]

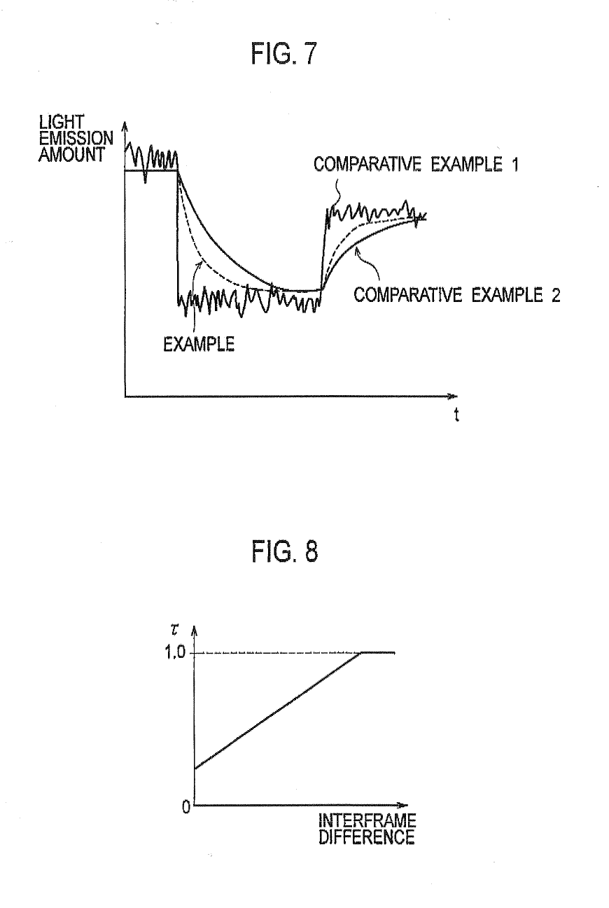

Hereinafter, a comparison result of an example and comparative examples will be described with reference to the drawing. FIG. 7 is a diagram showing the comparison result of the example and the comparative examples. FIG. 7 shows change in the light emission amount in each of Comparative Example 1, Comparative Example 2, and Example.

In Comparative Example 1, the light emission amount is controlled based on the target light amount L_{T} without using the time constant τ. In Comparative Example 2, the light emission amount is controlled based on the time constant τ and the target light amount L_{T}, and the time constant τ is a constant (small value). In Example, the light emission amount is controlled based on the time constant τ and the target light amount L_{T}, and a larger value is set for the time constant τ as the saturation becomes lower.

The time constant τ is not used in Comparative Example 1. In other words, since the light emission amount changes in synchronization with the target light amount L_{T}, change in the light emission amount is so drastic that “flickering” is caused.

Since the time constant τ is used in Comparative Example 2, no “flickering” is caused. Nonetheless, since the time constant τ is a constant (small value), followability of the light emission amount to the target light amount L_{T} is poor, so that “color shift” is caused.

In contrast to these, in Example, a larger value is set for the time constant τ when the saturation (in the first embodiment, the weighted mean saturation) becomes lower. Accordingly, suppression of “flickering” and suppression of “color shift” are compatible. Particularly in an image having remarkable “color shift” (image of low saturation), the followability of the light emission amount to the target light amount L_{T} is good, and “color shift” is suppressed.

### [Modification 1]

Hereinafter, Modification 1 of the first embodiment will be described with reference to the drawing. Differences between the first embodiment and Modification 1 will be mainly described below.

In the first embodiment, the time constant τ is set based on the weighted mean saturation. On the other hand, in Modification 1, the time constant τ is set based on a difference between the frames.

Specifically, a larger value is set for the time constant τ as the difference between the frames becomes larger, as shown in FIG. 8. The difference between the frames is calculated in accordance with the following equation.

ΔF=|Y_{A}(t)−Y_{A}(t−1)|+|Y_{D}(t)−Y_{D}(t−1)| [Equation 3]

wherein Y_{A}(t) is a mean value of luminance of the t-th frame, Y_{A}(t−1) is a mean value of luminance of the (t−1)-th frame, Y_{D}(t) is a standard deviation value of luminance of the t-th frame, and Y_{D}(t−1) is a standard deviation value of luminance of the (t−1)-th frame.

Here, when τ₁ is a time constant set based on the weighted mean saturation and τ₂ is a time constant set based on the difference between the frames, τ₁ or τ₂ may be used selectively as the time constant τ. Alternatively, a result obtained by multiplying τ₁ by τ₂ may be used as the time constant τ.

### (Advantageous Effect)

In Modification 1, a larger value is set for the time constant τ as the difference between the frames becomes larger. In other words, in scene change or the like having a large difference between the frames, a large value is set as the time constant τ. Accordingly, when it is unlikely to cause “flickering,” a larger value is used as the time constant τ to increase the followability of the light emission amount to the target light amount L_{T}.

### [Modification 2]

Hereinafter, Modification 2 of the first embodiment will be described with reference to the drawings. Differences between the first embodiment and Modification 2 will be mainly described below.

In the first embodiment, target gain G_{T}/gain upper limit value G_{LIM} is identical to target signal value LS_{T} (target light amount L_{T})/upper limit signal value LS_{LIM}. On the other hand, in Modification 2, the target gain G_{T} is set so that target gain G_{T}/gain upper limit value G_{LIM} may be different from target signal value LS_{T} (target light amount L_{T})/upper limit signal value LS_{LIM}.

Here, it is assumed that the target signal value LS_{T} and the target gain G_{T} are normalized by the gain upper limit value G_{LIM} (=1) and the upper limit signal value LS_{LIM} (=1).

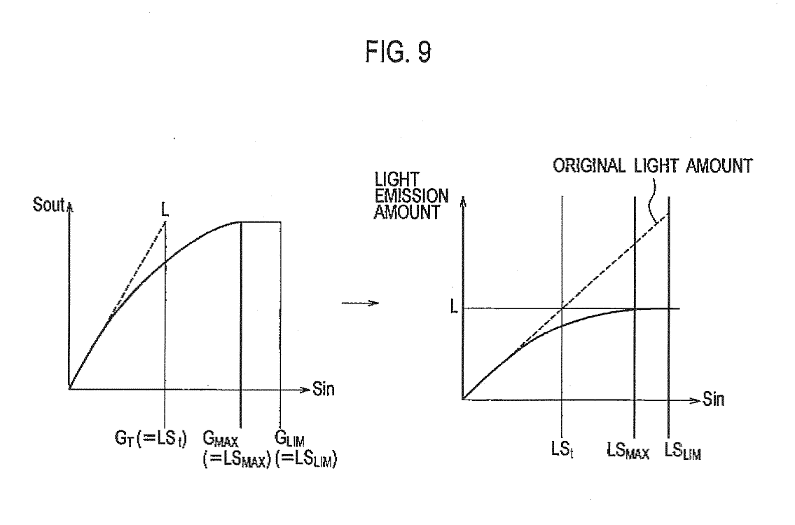

As shown in FIG. 9, when the target gain G_{T} is identical to the target signal value LS_{T} (target light amount L_{T}), inclination of the amount of light to be finally outputted from the projection display apparatus 100 is approximately equal to inclination of the amount of light corresponding to the video input signal (hereinafter, original light amount) in a lower luminance region. In other words, gradation corresponding to the video input signal (hereinafter, original gradation) is kept. On the other hand, inclination of the amount of light to be finally outputted from the projection display apparatus 100 is smaller than inclination of the original light amount in a higher luminance region. Namely, “gradation collapse” is caused in pixels having higher luminance.

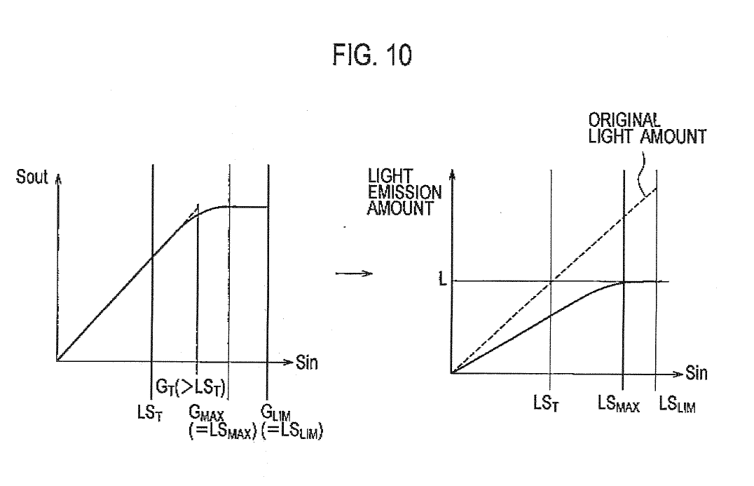

As shown in FIG. 10, compared with the case shown in FIG. 9, a luminance region where the original gradation is kept does not exist in the case where the target gain G_{T} is higher than the target signal value LS_{T} (target light amount L_{T}). However, compared with the case shown in FIG. 9, “gradation collapse” is suppressed in a higher luminance region.

The above-mentioned image analyzing unit 220 calculates the target gain G_{T} based on distribution of the signal values of the video input signals. For example, as the variance of the luminance calculated based on the video input signals becomes larger, the image analyzing unit 220 makes the target gain G_{T} larger than the target signal value LS_{T} (target light amount L_{T}). Moreover, when the luminance calculated based on the video input signals is distributed heavily in the lower luminance region, the image analyzing unit 220 brings the target gain G_{T} close to the target signal value LS_{T} (target light amount L_{T}).

### (Advantageous Effect)

In Modification 2, “gradation collapse” accompanied with the backlight control processing can be suppressed by separately controlling the target gain G_{T} and the target signal value LS_{T} (target light amount L_{T}).

For example, when the variance of the luminance calculated based on the video input signals is larger, “gradation collapse” in the higher luminance region can be suppressed by making the target gain G_{T} larger than the target signal value LS_{T} (target light amount L_{T}).

On the other hand, when the luminance calculated based on the video input signals is distributed heavily in the lower luminance region, the original gradation can be kept in the lower luminance region by bringing the target gain G_{T} close to the target signal value LS_{T} (target light amount L_{T}).

### [Modification 3]

Hereinafter, Modification 3 of the first embodiment will be described. Differences between the first embodiment and Modification 3 will be mainly described below.

In the first embodiment, the time constant τ is set based on the weighted mean saturation. On the other hand, in Modification 3, a fixed value is determined in advance as the time constant τ.

Specifically, the above-mentioned image analyzing unit 220 sets a fixed value for the time constant τ when the saturation calculated based on the signal values of the video input signals is higher than predetermined saturation. On the other hand, the image analyzing unit 220 sets a value larger than the fixed value for the time constant τ as the saturation calculated based on the signal values of the video input signals becomes lower than the predetermined saturation.

### (Advantageous Effect)

In Modification 3, the time constant τ that determines the upper limit value for the target light amount L_{T} is used in calculation of the target light amount L_{T}. Accordingly, “flickering” is suppressed. Moreover, as the saturation calculated based on the video input signals becomes lower than the predetermined threshold, a value larger than the fixed value is set for the time constant τ. Accordingly, deviation of the amount of light to be emitted from each light source unit 10 is suppressed, and “color shift” is suppressed.

### Second Embodiment

### (Configuration of Projection Display Apparatus)

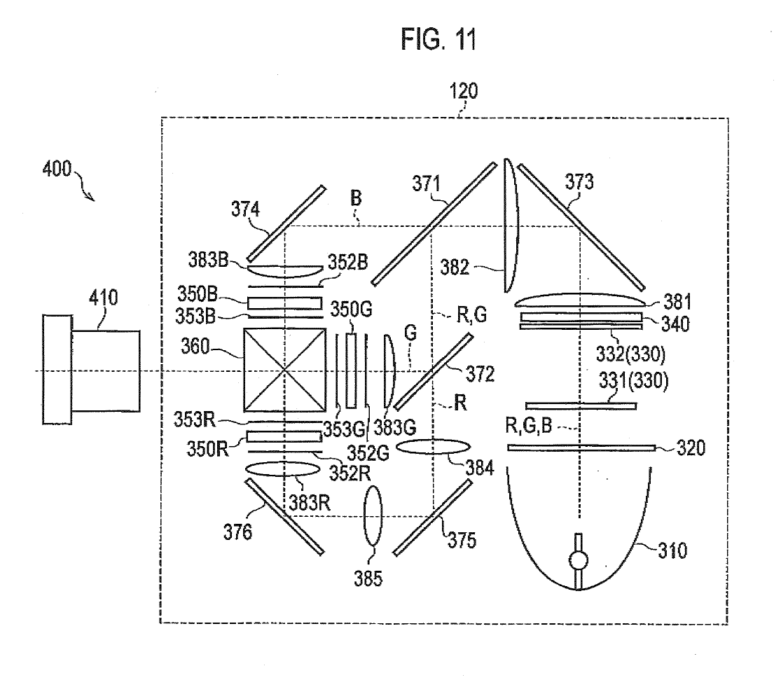

Hereinafter, a projection display apparatus according to a second embodiment will be described with reference to the drawing. FIG. 11 is a diagram showing a configuration of a projection display apparatus 400 according to the second embodiment.

As shown in FIG. 11, the projection display apparatus 400 includes a projection unit 410 and an illumination unit 420.

The projection unit 410 is configured to project image light emitted from the illumination unit 420, on a screen (not shown) or the like.

First, the illumination unit 420 includes a white light source 310, a UV/IR cut filter 320, a fly-eye lens unit 330, a PBS array 340, multiple liquid crystal panels 350 (liquid crystal panel 350R, liquid crystal panel 350G, and liquid crystal panel 350B), and a cross dichroic prism 360.

The white light source 310 is a light source configured to emit white light (for example, a UHP lamp or a xenon lamp). In other words, the white light emitted by the white light source 310 includes red component light R, green component light G, and blue component light B.

The UV/IR cut filter 320 is configured to transmit visible light components (red component light R, green component light G, and blue component light B). The UV/IR cut filter 330 shields infrared light components and ultraviolet light components.

The fly-eye lens unit 330 is configured to uniformize the light emitted by the white light source 310. Specifically, the fly-eye lens unit 330 is formed of a fly-eye lens 331 and a fly-eye lens 332. Each of the fly-eye lens 331 and the fly-eye lens 332 is formed of multiple microlenses. Each of the microlenses is configured to converge the light emitted by the white light source 310 so that the whole surface of each liquid crystal panel 350 may be irradiated with the light emitted by the white light source 310.

The PBS array 340 is configured to align the polarization states of the light emitted from the fly-eye lens unit 330. For example, the PBS array 340 aligns the light emitted from the fly-eye lens unit 330 so that the light may be S-polarized (or P-polarized).

The liquid crystal panel 350R is configured to modulate the red component light R based on the red output signals Rₒᵤₜ. A light-entering-side polarizing plate 352R configured to transmit light having one polarization direction (for example, S-polarized light) and to shield light having another polarization direction (for example, P-polarized light), is provided on a side where the light enters the liquid crystal panel 350R. A light-emitting-side polarizing plate 353R configured to shield light having one polarization direction (for example, S-polarized light) and to transmit light having another polarization direction (for example, P-polarized light), is provided on a side where the light is emitted from the liquid crystal panel 350R.

The liquid crystal panel 350G is configured to modulate the green component light G based on the green output signals Gₒᵤₜ. A light-entering-side polarizing plate 352G configured to transmit light having one polarization direction (for example, S-polarized light) and to shield light having another polarization direction (for example, P-polarized light), is provided on a side where the light enters the liquid crystal panel 350G. On the other hand, a light-emitting-side polarizing plate 353G configured to shield light having one polarization direction (for example, S-polarized light) and to transmit light having another polarization direction (for example, P-polarized light), is provided on a side where the light is emitted from the liquid crystal panel 350G.

The liquid crystal panel 350B is configured to modulate the blue component light B based on this blue output signals Bₒᵤₜ. A light-entering-side polarizing plate 352B configured to transmit light having one polarization direction (for example, S-polarized light) and to shield light having another polarization direction (for example, P-polarized light), is provided on a side where the light enters the liquid crystal panel 350B. On the other hand, a light-emitting-side polarizing plate 353B configured to shield light having one polarization direction (for example, S-polarized light) and to transmit light having another polarization direction (for example, P-polarized light) is provided on a side where the light is emitted from the liquid crystal panel 350B.

The red output signals Rₒᵤₜ, the green output signals Gₒᵤₜ, and the blue output signals Bₒᵤₜ form the video output signals. The video output signals are signals for multiple pixels forming one frame.

Here, a compensating plate (not shown) configured to improve a contrast ratio and transmittance may be provided in each of the liquid crystal panels 350. Moreover, each polarizing plate may have a pre-polarizing plate configured to reduce the amount of light entering the polarizing plate and the heat burden of the light.

The cross dichroic prism 360 forms a color combining unit configured to combine together the light emitted from the liquid crystal panel 350R, the liquid crystal panel 350G, and the liquid crystal panel 350B. The combine light emitted from the cross dichroic prism 360 is guided to the projection unit 410.

Next, the illumination unit 420 includes a mirror group (mirrors 371 to 376) and a lens group (lenses 381 to 385).

The mirror 371 is a dichroic mirror configured to transmit the blue component light B and to reflect the red component light R and the green component light G. The mirror 372 is a dichroic mirror configured to transmit the red component light R and to reflect the green component light G. The mirror 371 and the mirror 372 form a color separation unit configured to separate the red component light R, the green component light G, and the blue component light B.

The mirror 373 is configured to reflect the red component light R, the green component light G, and the blue component light B, and to guide the red component light R, the green component light G, and the blue component light B to the mirror 371 side. The mirror 374 is configured to reflect the blue component light B, and to guide the blue component light B to the liquid crystal panel 350B side. The mirror 375 and the mirror 376 are configured to reflect the red component light R, and to guide the red component light R to the liquid crystal panel 350R side.

The lens 381 is a condensing lens configured to converge the light emitted from the PBS array 340. The lens 382 is a condensing lens configured to converge the light reflected by the mirror 373.

The lens 383R is configured to make the red component light R approximately parallel light so that the liquid crystal panel 350R may be irradiated with the red component light R. The lens 383G is configured to make the green component light G approximately parallel light so that the liquid crystal panel 350G may be irradiated with the green component light G. The lens 383B is configured to make the blue component light B approximately parallel light so that the liquid crystal panel 350B may be irradiated with the blue component light B.

The lens 384 and the lens 385 are relay lenses configured to form approximately an image with the red component light R on the liquid crystal panel 350R while suppressing enlargement of the red component light R.

### (Configuration of Control Unit)

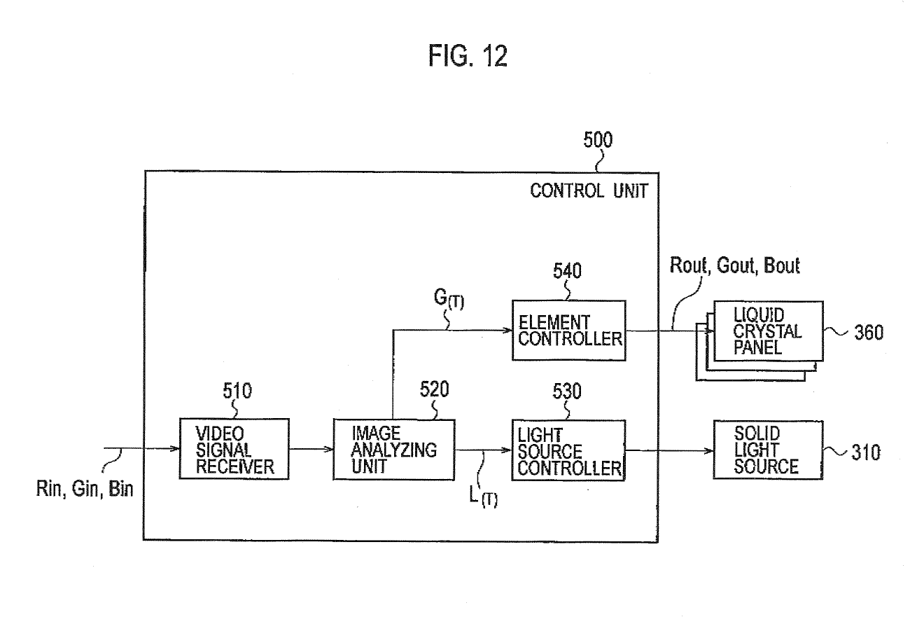

Hereinafter, a control unit according to the second embodiment will be described with reference to the drawings. FIG. 12 is a block diagram showing a control unit 500 according to the second embodiment. The control unit 500 is provided in the projection display apparatus 400, and configured to control the projection display apparatus 400.

As shown in FIG. 12, the control unit 500 includes a video signal receiver 510, an image analyzing unit 520, a light source controller 530, and an element controller 540.

The video signal receiver 510 is configured to receive video input signals from an external device (not shown) such as a DVD player or a TV tuner. The video input signals are formed of the red input signals Rᵢₙ, the green input signals Gᵢₙ, and the blue input signals Bᵢₙ. The video input signals are signals inputted respectively to multiple pixels forming one frame.

The image analyzing unit 520 is configured to perform preprocessing for backlight control processing. The backlight control processing is processing to control the amount of light to be emitted from the white light source 310, based on the signal values of the video input signals (for example, indexes that show brightness). Moreover, the backlight control processing is processing to convert the video input signals respectively into the video output signals in accordance with a control amount of the amount of light to be emitted from the white light source 310. Here, the backlight control processing is uniformly performed on all the colors.

In the second embodiment, the backlight control processing is uniformly performed on all the colors. Accordingly, among the red input signal Rᵢₙ, the green input signal Gᵢₙ, and the blue input signal Bᵢₙ, the maximum signal value (hereinafter, MAX(R, G, B)) is used as an index that shows brightness.

Specifically, the image analyzing unit 520 calculates the target light amount L_{T} and the target gain G_{T} based on the video input signals. The target light amount L_{T} is used for controlling the amount of light to be emitted from the white light source 310. The target gain G_{T} is used for controlling the conversion of the video input signals into the video output signals.

In the second embodiment, the target light amount L_{T} may be considered as a ratio of a representative value of MAX(R, G, B) for each of the multiple pixels forming the frame, and an upper limit signal value. Similarly to the target light amount L_{T}, the target gain G_{T} may be also considered as a ratio of a representative value of MAX(R, G, B) for each of the multiple pixels forming the frame, and the upper limit signal value. As the representative values of MAX(R, G, B), the maximum value for MAX(R, G, B) for each of the multiple pixels forming the frame, and a mean value of MAX(R, G, B) for each of the multiple pixels forming the frame, are used.

As mentioned above, the backlight control processing is uniformly performed on all the colors. Therefore, it should be noted that one target light amount L_{T} and one target gain G_{T} are calculated for all the colors.

Here, the image analyzing unit 520 calculates a time constant τ based on the signal values of the video input signals. The time constant τ is a value that determines the upper limit value for the amount of interframe change in the amount of light to be emitted from the white light source 310. Specifically, the image analyzing unit 520 calculates saturation (for example, the mean value of saturation) based on the signal values of the video input signals, and sets a larger value for the time constant τ as the saturation becomes higher.

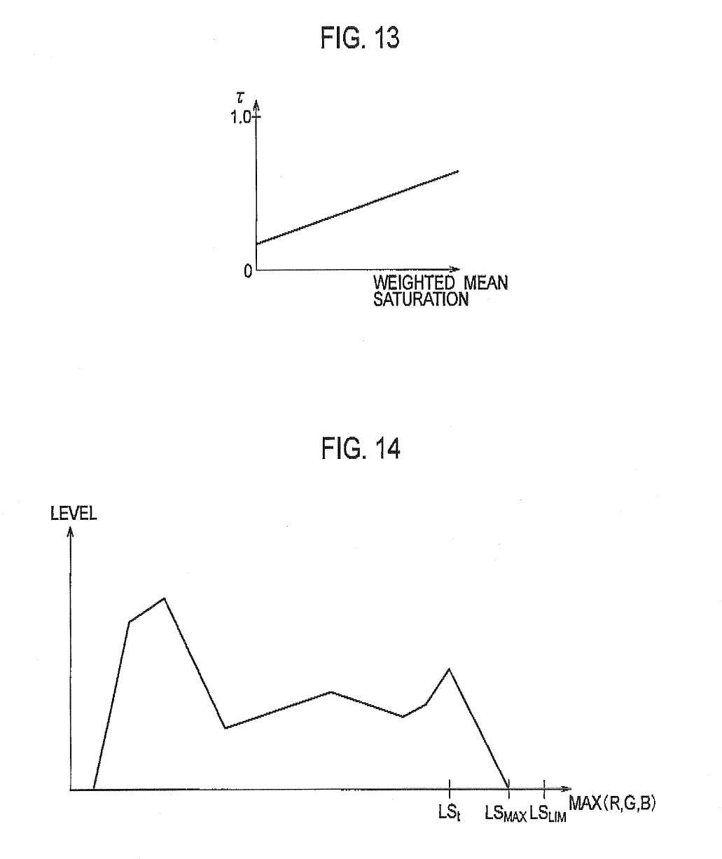

In the second embodiment, the image analyzing unit 520 calculates brightness based on the signal values of the video input signals. Then, the image analyzing unit 520 sets a larger value for the time constant τ as a mean value of a weighted saturation (hereinafter, weighted mean saturation) obtained by weighting the saturation by the brightness becomes higher. For example, as shown in FIG. 13, a larger value is set for the time constant τ as the weighted mean saturation becomes higher. The value of the time constant τ is within a range of the minimum (≧0) to the maximum value (≦1).

The weighted mean saturation WSₐᵥₑ is calculated in accordance with the following equation, for example. As shown in the following equation, use of the weighted mean saturation WSₐᵥₑ reduces computational complexity compared to the case of using the saturation.

$${WS}_{ave} = \frac{{\sum }_{i}^{k} {V}_{i} {S}_{i}}{k} = \frac{{\sum }_{i}^{k} ( {max}_{i} - {min}_{i} )}{k} \\ {V}_{i} = {max}_{i} \\ {S}_{i} = \frac{{max}_{i} - {min}_{i}}{{max}_{i}} \qquad [ Equation 4 ]$$

wherein maxᵢ=max(Rᵢ, Gᵢ, Bᵢ), minᵢ=min(Rᵢ, Gᵢ, Bᵢ), i=pixel position.

The image analyzing unit 520 outputs the target light amount L_{T} and the time constant τ to the light source controller 530. The image analyzing unit 520 also outputs the target gain G_{T} to the element controller 540.

The light source controller 530 is configured to control the amount of light to be emitted from the white light source 310, based on the target light amount L_{T} and the time constant τ. Specifically, the light source controller 530 controls the white light source 310 so that the amount of light to be emitted from the white light source 310 may be the light amount calculated using the target light amount L_{T} and the time constant τ.

The element controller 540 controls the signal values of the video input signals for the multiple pixels for each color of red, green, and blue. Specifically, the element controller 540 converts the video input signals for the multiple pixels respectively into the video output signals for the multiple pixels. In other words, the element controller 540 converts the red input signals Rᵢₙ into the red output signals Rₒᵤₜ. Similarly, the element controller 540 converts the green input signals Gᵢₙ into the green output signals Gₒᵤₜ, and converts the blue input signals Bᵢₙ into the blue output signals Bₒᵤₜ.

Based on the target gain G_{T}, the element controller 540 converts the red input signals Rᵢₙ into the red output signals Rₒᵤₜ so that the red output signals Rₒᵤₜ may become larger than the red input signals Rᵢₙ.

Similarly, based on the target gain G_{T}, the element controller 540 converts the green input signals Gᵢₙ into the green output signals Gₒᵤₜ so that the green output signals Gₒᵤₜ may become larger than the green input signals Gᵢₙ.

Based on the target gain G_{T}, the element controller 540 converts the blue input signals Bᵢₙ into the blue output signals Bₒᵤₜ so that the blue output signals Bₒᵤₜ may become larger than the blue input signals Bᵢₙ.

### (Light Source Control Processing)

Hereinafter, light source control processing of the backlight control processing according to the second embodiment will be described with reference to the drawing. FIG. 14 is a diagram showing the light source control processing according to the second embodiment. Specifically, FIG. 14 is a diagram showing a histogram of MAX(R, G, B) for each of the multiple pixels.

In FIG. 14, a maximum signal value LS_{MAX} is the maximum value for the video input signal (MAX(R, G, B)) for each of the multiple pixels. An upper limit signal value LS_{LIM} is the upper limit value for the video input signal (MAX(R, G, B)) for each of the multiple pixels. A target signal value LS_{T} is a signal value corresponding to the target light amount L_{T} calculated based on the video input signals (MAX(R, G, B)).

As shown in FIG. 14, when the maximum signal value LS_{MAX} is smaller than the upper limit signal value LS_{LIM}, the amount of light to be emitted from the white light source can be reduced. As mentioned above, the light source controller 530 controls the white light source so that the amount of light to be emitted from the white light source may be the light amount calculated based on the target light amount L_{T} and the time constant τ.

### (Signal Control Processing)

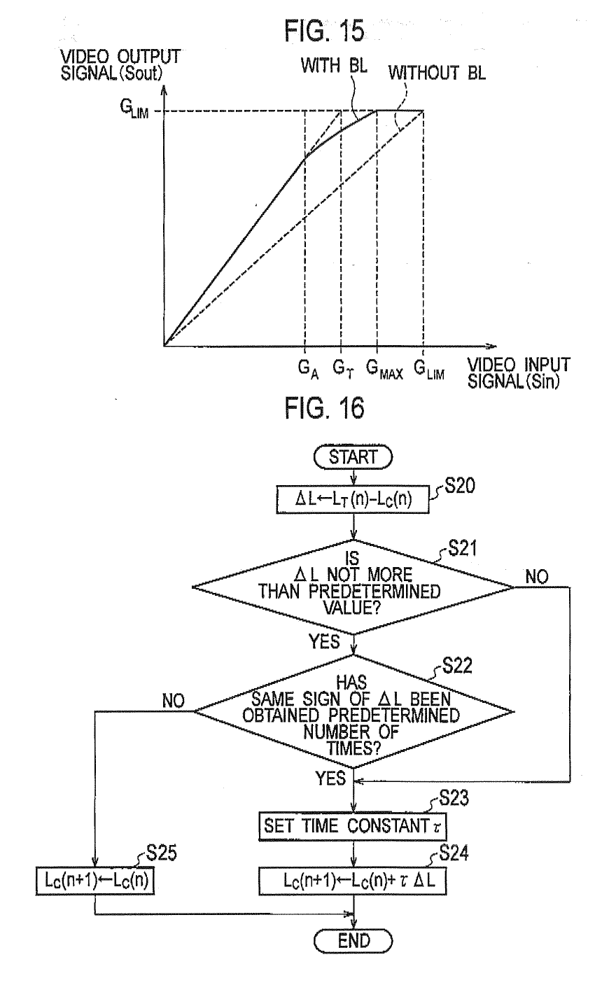

Hereinafter, signal control processing of the backlight control processing according to the second embodiment will be described with reference to the drawing. FIG. 15 is a diagram showing the signal control processing according to the second embodiment. Specifically, FIG. 15 is a diagram showing conversion characteristics for converting the video input signal into the video output signal.

In FIG. 15, a gain maximum value G_{MAX} is the maximum value for the video input signal (MAX(R, G, B)) for each of the multiple pixels. A gain upper limit value G_{LIM} upper limit value for the video input signal (MAX(R, G, B)) for each of the multiple pixels. The target gain G_{T} is a value calculated, based on the target light amount L_{T} (or target signal value LS_{T}). For example, target gain G_{T}/gain upper limit value G_{LIM} is identical to target signal value LS_{T}/upper limit signal value LS_{LIM}.

As a premise, a conversion rate of the video input signal (Sᵢₙ) to the video output signal (Sₒᵤₜ) is 1 to 1 when the backlight control processing is not performed, as shown in FIG. 15.

Under the assumption of such a relationship, the conversion rate of the video input signal (Sᵢₙ) to the video output signal (Sₒᵤₜ) when the backlight control processing is performed is represented by the following equation.

$${S}_{out} = {S}_{in} \times \frac{{G}_{LIM}}{{G}_{T}} ( O \leq {S}_{in} \leq {G}_{A} ) \\ {S}_{out} = {G}_{LIM} - \frac{{{G}_{LIM} ( {G}_{LIM} - {S}_{in} )}^{2}}{4 {G}_{T} ( {G}_{MAX} - {G}_{T} )} ( {G}_{A} < {S}_{in} \leq {G}_{MAX} ) \\ {S}_{out} = {G}_{LIM} ( {G}_{MAX} < {S}_{in} \leq {G}_{LIM} ) \qquad [ Equation 5 ]$$

wherein G_{A}=2 G_{T}·G_{MAX}, G_{LIM}=gain upper limit value, G_{MAX}=gain maximum value, G_{T}=target gain.

### (Operation of Projection Display Apparatus)

Hereinafter, operation of the projection display apparatus according to the second embodiment will be described with reference to the drawing. FIG. 16 is a flow chart showing operation of the projection display apparatus 400 according to the second embodiment. Specifically, FIG. 16 is a diagram showing a method for determining the light emission amount of the (n+1)-th frame.

In FIG. 16, L_{T}(n) is the target light amount L_{T} of the n-th frame L_{C}(n) is the light emission amount of the n-th frame L_{C}(n+1) is the light emission amount of the (n+1)-th frame.

As shown in FIG. 16, at Step 20, the control unit 500 sets a difference between the target light amount L_{T}(n) and the light emission amount L_{C}(n), as ΔL.

At Step 21, the control unit 500 determines whether ΔL is not more than a predetermined value. The control unit 500 goes to processing of Step 22 when ΔL is not more than the predetermined value. On the other hand, the control unit 500 goes to processing of Step 23 when ΔL is larger than the predetermined value.

At Step 22, the control unit 500 determines whether the same sign of ΔL has been obtained a predetermined number of times. In other words, the control unit 500 determines whether the target light amount L_{T} is continuously increased (or decreased) in a predetermined number of frames. The control unit 500 goes to the processing of Step 23 when the same sign of ΔL has been obtained the predetermined number of times. On the other hand, the control unit 500 goes to processing of Step 25 when the same sign of ΔL has not been obtained the predetermined number of times.

At Step 23, the control unit 500 sets the time constant τ based on the saturation (in the second embodiment, the weighted mean saturation) calculated based on the video input signals (MAX(R, G, B)). As the video input signals (MAX(R, G, B)), the video input signals (MAX(R, G, B)) for the multiple pixels forming the n-th frame are used, for example.

At Step 24, the control unit 500 adds a value obtained by multiplying ΔL by the time constant τ, to the light emission amount L_{C}(n). The control unit 500 sets the result of the calculation as the light emission amount L_{C}(n+1).

At Step 25, the control unit 500 sets the light emission amount L_{C}(n) as the light emission amount L_{C}(n+1).

### (Advantageous Effect)

In the second embodiment, in control of the light emission amount, the time constant τ that determines the upper limit value for the amount of change in the light amount is used. Accordingly, “flickering” is suppressed. Moreover, a larger value is set for the time constant τ as the saturation calculated based on the video input signals becomes higher. Accordingly, “color shift” is suppressed in an image with high saturation having a noticeable difference in the light amount drop contribution among the video input signals Rᵢₙ, Gᵢₙ, and Bᵢₙ.

In the second embodiment, a larger value is set for the time constant τ as the weighted mean saturation becomes higher. An image having high weighted mean saturation has many pixels of red, green, or blue with high saturation. A pixel having high saturation has a noticeable difference in the light amount drop contribution. In such an image, a large value is set as the time constant τ thereby to suppress “color shift.”

Here, consider a case of a pixel having high saturation, i.e., a case where the signal values of the red input signal Rᵢₙ, the green input signal Gᵢₙ, and the blue input signal Bᵢₙ have a relationship of (Rᵢₙ, Gᵢₙ, Bᵢₙ)=(255, 128, 0) and the upper limit signal value is “255.” Moreover, consider a case where the target signal value LS_{T} is a half of the upper limit signal value LS_{LIM}, i.e., a case where the amount of light to be emitted from the white light source 310 is ½.

In such control, the red input signal Rᵢₙ, the green input signal Gᵢₙ, and the blue input signal Bᵢₙ are doubled. However, since the upper limit signal value is “255,” the signal value of the red output signal Rₒᵤₜ cannot be increased by the signal control processing. As a result, the red output signal Rₒᵤₜ, the green output signal Gₒᵤₜ, and the blue output signal Bₒᵤₜ have a relationship of (Rₒᵤₜ, Gₒᵤₜ, Bₒᵤₜ)=(255, 255, 0).

As described above, in the backlight control processing, when the amount of light emitted from the white light source 310 is reduced and the signal value is increased by the signal control processing, a pixel having high saturation has a noticeable difference in the light amount drop contribution. For instance, in the example mentioned above, (Rₒᵤₜ, Gₒᵤₜ, Bₒᵤₜ)=(255, 255, 0) causes “color shift” from (Rᵢₙ, Gᵢₙ, Bᵢₙ) (255, 128, 0).

Incidentally, the light amount drop contribution is a degree of increase in the signal value within a range not exceeding the upper limit signal value, when the amount of light to be emitted from the white light source 310 is reduced and the signal value is increased by the signal control processing, in the backlight control processing. For instance, in the example of the mentioned above, the red input signal Rᵢₙ (red output signal Rₒᵤₜ) has a small light amount drop contribution, and the green input signal Gᵢₙ (green output signal Gₒᵤₜ) has a large light amount drop contribution.

### [Comparison Result]

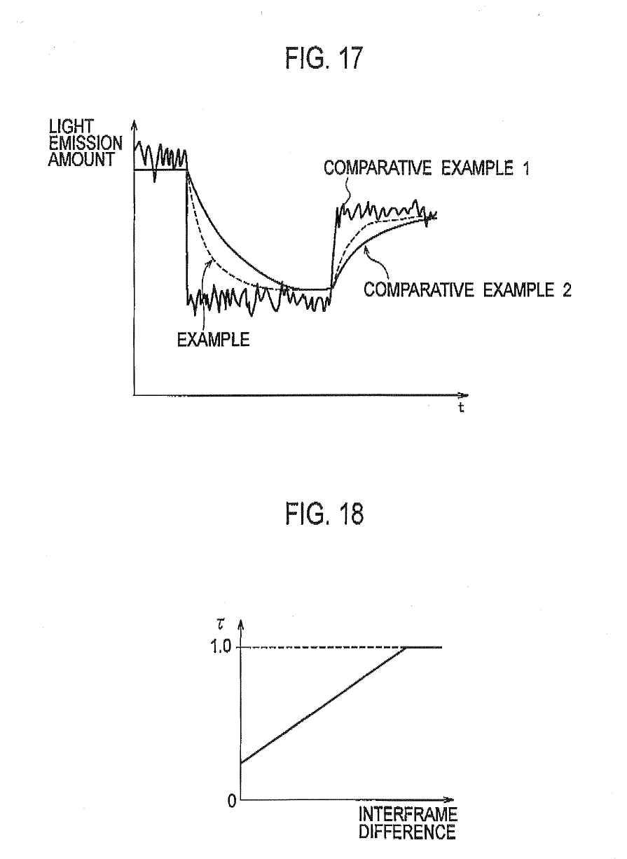

Hereinafter, a comparison result of an example and comparative examples will be described with reference to the drawing. FIG. 17 is a diagram showing a comparison result of an example and comparative examples. FIG. 17 shows change in the light emission amount in each of Comparative Example 1, Comparative Example 2, and Example.

In Comparative Example 1, the light emission amount is controlled based on the target light amount L_{T} without using the time constant τ. In Comparative Example 2, the light emission amount is controlled based on the time constant τ and the target light amount L_{T}, and the time constant τ is a constant (small value). In Example, the light emission amount is controlled based on the time constant τ and the target light amount L_{T}, and a larger value is set for the time constant τ as the saturation becomes higher.

The time constant τ is not used in Comparative Example 1. In other words, since the light emission amount changes in synchronization with the target light amount L_{T}, change in the light emission amount is so drastic that “flickering” is caused.

Since the time constant τ is used in Comparative Example 2, no “flickering” is caused. Nonetheless, since the time constant τ is a constant (small value), followability of the light emission amount to the target light amount L_{T} is poor so that “color shift” is caused.

In contrast to these, in Example, a larger value is set for the time constant τ as the saturation (in the second embodiment, the weighted mean saturation) becomes higher. Accordingly, suppression of “flickering” and suppression of “color shift” are compatible. Particularly in an image having remarkable “color shift” (image of high saturation), the followability of the light emission amount to the target light amount L_{T} is good, and “color shift” is suppressed.

### [Modification 1]

Hereinafter, Modification 1 of the second embodiment will be described with reference to the drawing. Differences between the second embodiment and Modification 1 will be mainly described below.

In the second embodiment, the time constant τ is set based on the weighted mean saturation. On the other hand, in Modification 1, the time constant τ is set based on a difference between the frames.

Specifically, a larger value is set for the time constant τ as the difference between the frames becomes larger, as shown in FIG. 18. The difference between the frames is calculated in accordance with the following equation.

ΔF=|Y_{A}(t)−Y_{A}(t−1)|+|Y_{D}(t)−Y_{D}(t−1)| [Equation 6]

wherein Y_{A}(t) is a mean value of luminance of the t-th frame, Y_{A}(t−1) is a mean value of luminance of the (t−1)-th frame, Y_{D}(t) is a standard deviation value of luminance of the t-th frame, and Y_{D}(t−1) is a standard deviation value of luminance of the (t−1)-th frame.

Here, when τ₁ is a time constant set based on the weighted mean saturation and τ₂ is a time constant set based on the difference between the frames, τ₁ or τ₂ may be used selectively as the time constant τ. Alternatively, a result obtained by multiplying τ₁ by τ₂ may be used as the time constant τ.

### (Advantageous Effect)

In Modification 1, a larger value is set for the time constant τ as the difference between the frames becomes larger. In other words, in scene change or the like having a large difference between the frames, a large value is set as the time constant τ. Accordingly, when it is unlikely to cause “flickering,” a larger value is used as the time constant τ to increase the followability of the light emission amount to the target light amount L_{T}.

### [Modification 2]

Hereinafter, Modification 2 of the second embodiment will be described with reference to the drawings. Differences between the second embodiment and Modification 2 will be mainly described below.

In the second embodiment, target gain G_{T}/gain upper limit value G_{LIM} is identical to target signal value LS_{T} (target light amount L_{T})/upper limit signal value LS_{LIM}. On the other hand, in Modification 2, the target gain G_{T} is set so that target gain G_{T}/gain upper limit value G_{LIM} may be different from target signal value LS_{T} (target light amount L_{T})/upper limit signal value LS_{LIM}.

Here, it is assumed that the target signal value LS_{T} and the target gain G_{T} are normalized by the gain upper limit value G_{LIM} (=1) and the upper limit signal value LS_{LIM} (=1).

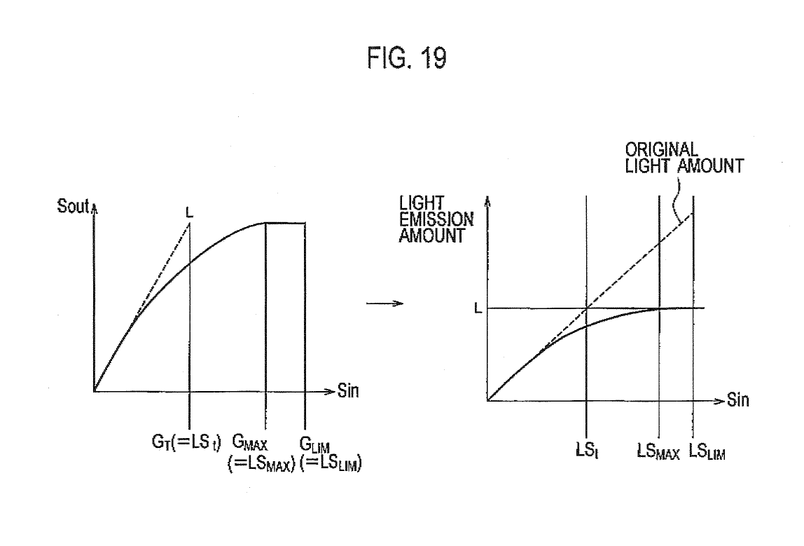

As shown in FIG. 19, when the target gain G_{T} is identical to the target signal value LS_{T} (target light amount L_{T}), inclination of the amount of light to be finally outputted from the white light source 310 is approximately equal to inclination of the amount of light corresponding to the video input signal (hereinafter, original light amount) in a lower luminance region. In other words, gradation corresponding to the video input signal (hereinafter original gradation) is kept. On the other hand, inclination of the amount of light to be finally outputted from the white light source 310 is smaller than inclination of the original light amount in a higher luminance region. Namely, “gradation collapse” is caused in pixels having higher luminance.

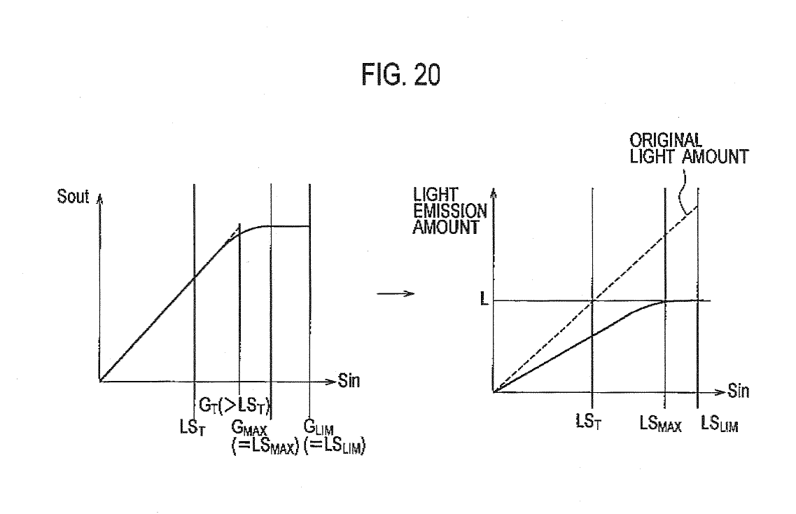

As shown in FIG. 20, compared with the case shown in FIG. 19, a luminance region where the original gradation is kept does not exist in the case where the target gain G_{T} is higher than the target signal value LS_{T} (target light amount L_{T}). However, compared with the case shown in FIG. 19, “gradation collapse” is suppressed in a higher luminance region.

The above-mentioned image analyzing unit 520 calculates the target gain G_{T} based on distribution of the signal values of the video input signals. For example, as the variance of the luminance calculated based on the video input signals becomes larger, the image analyzing unit 520 makes the target gain G_{T} larger than the target signal value LS_{T} (target light amount L_{T}). Moreover, when the luminance calculated based on the video input signals is distributed heavily in the lower luminance region, the image analyzing unit 520 brings the target gain G_{T} close to the target signal value LS_{T} (target light amount L_{T}).

### (Advantageous Effect)

In Modification 2, “gradation collapse” accompanied with the backlight control processing can be suppressed by separately controlling the target gain G_{T} and the target signal value LS_{T} (target light amount L_{T}).

For example, when the variance of the luminance calculated based on the video input signals is larger, “gradation collapse” in the higher luminance region can be suppressed by making the target gain G_{T} larger than the target signal value LS_{T} (target light amount L_{T}).

On the other hand, when the luminance calculated based on the video input signals is distributed heavily in the lower luminance region, the original gradation can be kept in the lower luminance region by bringing the target gain G_{T} close to the target signal value LS_{T} (target light amount L_{T}).

### [Modification 3]

Hereinafter, Modification 3 of the second embodiment will be described. Differences between the second embodiment and Modification 3 will be mainly described below.

In the second embodiment, the time constant τ is set based on the weighted mean saturation. On the other hand, in Modification 3, a fixed value is determined in advance as the time constant τ.

Specifically, the above-mentioned image analyzing unit 520 sets a fixed value as the time constant τ when the saturation calculated based on the signal value of the video input signals is lower than predetermined saturation. On the other hand, the image analyzing unit 520 sets a value larger than the fixed value for the time constant τ as the saturation calculated based on the signal value of the video input signals becomes higher than the predetermined saturation.

### (Advantageous Effect)

In Modification 3, the time constant τ that determines the upper limit value for the target light amount L_{T} is used in calculation of the target light amount L_{T}. Accordingly, “flickering” is suppressed. Moreover, when the saturation calculated based on the video input signals is higher than the predetermined threshold, a value larger than the fixed value is set as the time constant τ. Accordingly, in an image with high saturation having a noticeable difference in the light amount drop contribution among the video input signals Rᵢₙ, Gᵢₙ, and Bᵢₙ, “color shift” is suppressed.

### [Modification 4]

Hereinafter, Modification 4 of the second embodiment will be described with reference to the drawing. Differences between the second embodiment and Modification 4 will be mainly described below.

In the second embodiment, a projection display apparatus is illustrated as the image display apparatus. On the other hand, in Modification 4, an image display apparatus in which a white light source is used as a backlight will be illustrated as the image display apparatus.

### (Configuration of Image Display Apparatus)

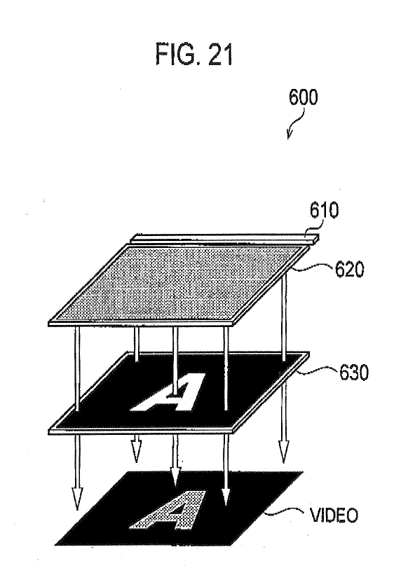

Hereinafter, an image display apparatus according to Modification 4 will be described with reference to the drawing. FIG. 21 is a diagram showing an image display apparatus 600 according to Modification 4.

As shown in FIG. 21, the image display apparatus 600 includes a white light source unit 610, a light guide plate 620, and a liquid crystal panel 630.

The white light source unit 610 is configured to emit the white light including the red component light R, the green component light G, and the blue component light B. For example, the white light source unit 610 has a solid light source that emits the white light. The solid light source is a laser diode (LD) or a light emitting diode (LED).

The white light source unit 610 may be an array light source formed of multiple solid light sources. Note that the number of solid light sources provided in the white light source unit 610 is not limited.

The white light source unit 610 may be configured to emit the white light by combining together light of multiple colors which are to be emitted respectively from solid light sources of the multiple colors.

The light guide plate 620 is configured to guide the white light emitted from the white light source unit 610, to the liquid crystal panel 630. Specifically, the light guide plate 620 reflects the white light emitted from the white light source unit 610, to the liquid crystal panel 630 side.

The liquid crystal panel 630 is a light valve configured to modulate the white light emitted from the white light source unit 610. Specifically, the liquid crystal panel 630 has multiple pixels, and each pixel is formed of a red subpixel, a green subpixel, and a blue subpixel.

The liquid crystal panel 630 controls a modulation amount in the red subpixel based on the red output signal Rₒᵤₜ. Similarly, the liquid crystal panel 630 controls the modulation amount in the green subpixel and that in the blue subpixel based on the green output signal Gₒᵤₜ and the blue output signal Bₒᵤₜ, respectively.

### Other Embodiments

While the present invention has been described with the above-mentioned embodiments, it is to be understood that the statements and drawings that make a part of this disclosure will not limit the present invention. From this disclosure, various alternative embodiments, examples, and implementation techniques will be apparent to persons skilled in the art.

For example, while the transmission type liquid crystal panel 60 has been described as an example of the light valve, the light valve will not be limited to this. The light valve may be a reflection type liquid crystal panel or a digital micromirror device (DMD).

For example, while the transmission type liquid crystal panel 350 has been described as an example of the light valve, the light valve will not be limited to this. The light valve may be a reflection type liquid crystal panel or a digital micromirror device (DMD).

The term “backlight control processing” in the specification is not limited to the scope for controlling the light irradiated from the back surface of the transmission type liquid crystal panel 350. The term “backlight control processing” in the specification may be considered as controlling the light irradiated on the front surface of the reflection type liquid crystal panel or the DMD, when the reflection type liquid crystal panel or the DMD is used as the light valve.

What is claimed is:

1. An image display apparatus including a light source, and a light valve configured to modulate light emitted from the light source, based on video input signals of a plurality of colors provided respectively for a plurality of pixels forming a frame, the image display apparatus comprising:
a light source controller configured to control amount of light to be emitted from the light source;
an element controller configured to separately control signal values of the video input signals of the plurality of colors; and
an image analyzing unit configured to calculate a target light amount based on the signal values of the video input signals of the plurality of colors, wherein
the light source controller controls the amount of the light to be emitted from the light source, based on the target light amount and a time constant,
the time constant is a value that determines an upper limit value for an amount of interframe change in the amount of the light to be emitted from light source, and
the image analyzing unit calculates saturation based on the signal values of the video input signals of the plurality of colors, and sets the time constant according to the saturation.

2. The image display apparatus according to claim 1, wherein
the light source includes a plurality of solid light sources, and
the image analyzing unit sets a larger value for the time constant as the saturation becomes lower.

3. The image display apparatus according to claim 2, wherein the image analyzing unit calculates brightness based on the signal values of the video input signals of the plurality of colors, and sets a larger value for the time constant as weighted saturation obtained by weighting the saturation by the brightness becomes lower.

4. The image display apparatus according to claim 2, wherein the image analyzing unit calculates an interframe difference as a difference in the signal value of each of the video input signals of the plurality of colors between the frames, and calculates the time constant based on the interframe difference.

5. The image display apparatus according to claim 2, wherein
the image analyzing unit calculates a target gain for each of the video input signals of the plurality of colors based on distribution of the signal values of the video input signals of the plurality of colors, and
the element controller separately controls the video input signals of the plurality of colors based on the respective target gains.

6. The image display apparatus according to claim 1, wherein
the light source includes a plurality of solid light sources,
the image analyzing unit sets a predetermined fixed value for the time constant when the saturation is higher than predetermined saturation, and sets a larger value than the fixed value for the time constant as the saturation becomes lower than the predetermined saturation.

7. The image display apparatus according to claim 1, wherein
the light source is a white light source, and
the image analyzing unit sets a larger value for the time constant as the saturation becomes higher.

8. The image display apparatus according to claim 7, wherein the image analyzing unit calculates brightness based on the signal values of the video input signals of the plurality of colors, and sets a larger value for the time constant as a weighted saturation obtained by weighting the saturation by the brightness becomes higher.

9. The image display apparatus according to claim 7, wherein the image analyzing unit calculates an interframe difference as a difference in the signal value of each of the video input signals of the plurality of colors between the frames, and calculates the time constant based on the interframe difference.

10. The image display apparatus according to claim 7, wherein
the image analyzing unit calculates a target gain based on distribution of the signal values of the video input signals of the plurality of colors, and
the element controller separately controls the video input signals of the plurality of colors based on the target gain.

11. The image display apparatus according to claim 1, wherein
the light source is a white light source,
the image analyzing unit sets a predetermined fixed value for the time constant as the saturation becomes lower than predetermined saturation, and sets a larger value than the fixed value for the time constant as the saturation becomes higher than the predetermined saturation.

12. A projection display apparatus including a light source, a light valve, and a projection unit, the light valve configured to modulate light emitted from the light source, based on video input signals of a plurality of colors provided respectively for a plurality of pixels forming a frame, the projection display apparatus comprising:
a light source controller configured to control amount of light to be emitted from the light source;
an element controller configured to separately control signal values of the video input signals of the plurality of colors; and
an image analyzing unit configured to calculate a target light amount based on the signal values of the video input signals of the plurality of colors, wherein
the light source controller controls the amount of the light to be emitted from the light source, based on the target light amount and a time constant,
the time constant is a value that determines an upper limit value for an amount of interframe change in the amount of the light to be emitted from light source, and
the image analyzing unit calculates saturation based on the signal values of the video input signals of the plurality of colors, and sets the time constant according to the saturation.
